(19) United States
(12) Patent Application Publication
(10) Pub. No.: US 2014/0015369 A1
(43) Pub. Date: Jan. 16, 2014

(54) Systems and Methods for Electric Motor Construction

(71) Applicant: Baker Hughes Incorporated, Houston, TX (US)

(72) Inventor: John M. Knapp, Claremore, OK (US)

(21) Appl. No.: 13/911,458

(22) Filed: Jun. 6, 2013

Related U.S. Application Data
(60) Provisional application No. 61/669,949, filed on Jul. 10, 2012.

(51) Int. Cl. H02K 15/02; H02K 1/16

(52) U.S. Cl. CPC H02K 15/024; H02K 1/16
USPC 310/216.048; 29/596

(57) ABSTRACT

Systems and methods for the construction of electric motors, where multiple laminations within the stator core incorporate interlocking features such as dimples and corresponding depressions or recesses to prevent the laminations from rotating with respect to each other. The end laminations of the stack are welded to snap rings, and the snap rings are welded to the housing to prevent rotation of the laminations within the stator housing. The use of the interlocking features to prevent rotation of the laminations within the housing eliminates the need for compression of the laminations and the use of encapsulants to prevent rotation of the laminations.

### CROSS-REFERENCE TO RELATED APPLICATIONS

This application claims the benefit of U.S. Provisional Patent Application 61/669,949 by John M. Knapp, filed Jul. 10, 2012, which is incorporated by reference as if set forth herein in its entirety.

### BACKGROUND

1. Field of the Invention

The invention relates generally to the construction of electric motors, and more particularly to systems and methods for constructing electric motors in which laminations of a stator core are prevented from rotating in a housing without the use of encapsulants or a high degree of compression.

2. Related Art

A typical electric motor has two primary components: a rotor; and a stator. The stator is a stationary component, while the rotor is a movable component which rotates with respect to the stator. In an AC induction motor, a magnetic field is induced into the rotor. The interaction of the magnetic fields created by the stator and the rotor cause the rotor to rotate with respect to the stator.

The motor incorporates electromagnets that generate changing magnetic fields when current supplied to the electromagnets is varied. These electromagnets are normally formed by positioning coils (windings) of insulated wire around ferromagnetic cores. In an AC induction motor, the ferromagnetic cores are formed between “slots” in the stator core. When electric current is passed through the wire, magnetic fields are generated around the wire and consequently in the ferromagnetic cores. Changing the magnitude and direction of the current changes the magnitude and polarity of the magnetic fields generated by the electromagnets.

Electric motors that are designed for downhole applications (such as driving an electric submersible pump) are typically AC induction motors. These motors, generally speaking, are long and skinny. Usually, downhole motors are less than 10 inches in diameter, and they may be tens of meters long. This extremely elongated shape drives many aspects of a downhole motor's design. For example, rather than machining or otherwise manufacturing the stator core of a downhole motor as a single piece, it may be convenient to form the stator core by stacking many (e.g., thousands of) annular metal laminations within a housing. In order to keep the laminations from rotating within the housing, the laminations are tightly compressed against each other. The friction of the compressed laminations may not be sufficient to prevent their rotation, so the slots of the stator are typically filled (after magnet wires are installed) with an encapsulant such as epoxy or varnish, which helps to hold the laminations in position.

Several problems arise, however, as a result of this conventional construction. For example, because the laminations may not be perfectly flat (i.e., the thickness of each lamination may vary across each lamination), the cumulative thickness error of the laminations typically causes the stator to bend when the laminations are compressed against each other. It is therefore typically necessary to perform multiple straightening operations to correct this bending. The straightening operations are generally costly, time consuming, and require a substantial amount of factory space. Another problem with conventional construction is that, since the slots in the stator are filled with an encapsulant, the laminations (and the stator as a whole) cannot be reused. Consequently, if a stator fails (e.g., due to an electrical fault), the stator must be discarded and replaced with a new one, rather than being repaired or remanufactured.

It would therefore be desirable to provide systems and methods for manufacturing stators for downhole motors that do not rely on compression and encapsulants to prevent the rotation of laminations within the stator housing.

### SUMMARY OF THE INVENTION

The present invention includes systems and methods relating to the construction of electric motors. Exemplary embodiments of the invention include a stator core for an electric submersible pump motor in which the multiple laminations within the stator core incorporate interlocking features such as dimples and corresponding depressions to prevent the laminations from rotating with respect to each other, and the end laminations of the stack are welded or otherwise affixed to the housing to prevent rotation of the laminations with respect to the stator housing. Another exemplary embodiment is a method for compressionless, encapsulant-free manufacture of a stator core, in which dimples are formed in a set of stator core laminations, the laminations are stacked with their dimples interlocked, the stack is inserted into a stator housing, snap rings are inserted into grooves in the housing to maintain the position of the laminations, and the lamination at each end of the stack is welded to the adjacent snap ring and to the stator housing.

One embodiment comprises a stator core comprising a stator housing and a plurality of stator core laminations that are stacked together and positioned within the stator housing. Each of the plurality of stator core laminations has two opposing faces, one of which has at least one protruding interlocking structure, and the other of which has at least one recess. The interlocking structures and recesses of adjacent stator core laminations interlock and thereby prevent rotation each stator core lamination with respect to others of the plurality of stator core laminations. A pair of snap rings may be positioned on opposite ends of the stack of the stator core laminations and seated in corresponding grooves on the interior of the stator housing. The snap rings retain the stack of stator core laminations within the stator housing, and may be welded to both the end laminations and the housing to prevent relative rotation of the laminations and the housing.

The interlocking structures may be small dimples or structures of other sizes and shapes. The recesses have shapes and sizes that correspond to the dimples or other interlocking structures. The laminations may be stamped to form the dimples and recesses at the same time, or they may be formed by other means. In one embodiment, each of the plurality of stator core laminations is identical. Because the laminations are stacked together and interlocked, no encapsulant is necessary to prevent them from rotating, so the stator core may be encapsulant-free. The interlocking of the laminations also eliminates the need to provide high compression of the stack which is sometimes used to increase friction between the laminations and thereby prevent their relative rotation.

An alternative embodiment comprises an ESP motor that includes a stator and a rotor that is rotatably positioned within the stator. The stator has a set of stator core laminations that are stacked together and positioned within the stator housing. Each of the laminations has two opposing faces, one of which has one or more protruding dimples (or other interlocking structures) and the other of which has one or more corresponding recesses. The dimples and recesses of adjacent laminations interlock and thereby prevent rotation of laminations with respect to each other. Snap rings are positioned on opposite ends of the stack of the stator core laminations and are welded to both the end laminations in the stack and the housing to prevent rotation of the laminations with respect to the housing.

Another alternative embodiment is a method for constructing a stator for an ESP motor. In this method, a set of stator core laminations are provided. The stator core laminations have interlocking dimples or similar protruding structures and corresponding recesses. The stator core laminations are stacked so that the dimples and recesses of adjacent stator core laminations are interlocked. The stacked stator core laminations are then inserted into a stator housing. Snap rings are installed in the interior of the stator housing at the ends of the stack of laminations to retain the laminations in the housing. The snap rings are then welded to lamination at each end of the stack and to the housing to prevent rotation of the laminations with respect to the housing.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the general structure of a stator core in one embodiment.

FIGS. 2 and 3 are diagrams illustrating the configuration of a lamination for a closed-slot stator core in one embodiment.

FIG. 4 is a flow diagram illustrating a method for manufacturing a compression less, encapsulant-free stator core in one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for construction of electric motors in which a stator core in which the multiple laminations within the core incorporate interlocking features such as dimples and corresponding depressions to prevent the laminations from rotating with respect to each other, and the end laminations of the stack are welded or otherwise affixed to the housing to prevent rotation of the laminations with respect to the stator housing. In one embodiment, the stator is used in a motor for a system such as an electric submersible pump (ESP).

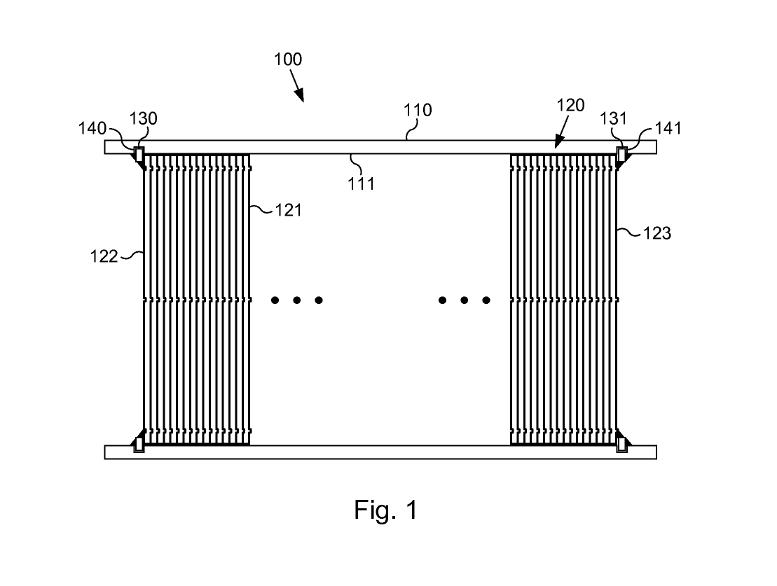

Referring to FIG. 1, a stator core for a downhole motor in accordance with one embodiment is shown. FIG. 1 is a partially cut-away view of stator core 100. Stator core 100 includes a tubular stator housing 110 and a stack 120 of magnetic laminations (e.g., 121) that are positioned within the housing. The laminations may be identical, although this is not necessarily the case. The laminations may be made of the same material, or some of them may be made of different materials, particularly in rotating bearing areas. In the embodiment of FIG. 1, a pair of snap rings 130 and 131 are positioned at the ends of stack 120. Snap rings 130 and 131 are seated within corresponding grooves 140 and 141 in the inner surface 111 of housing 110. In this embodiment, the laminations (122, 123) at the ends of stack 120 are welded to snap rings 130 and 131.

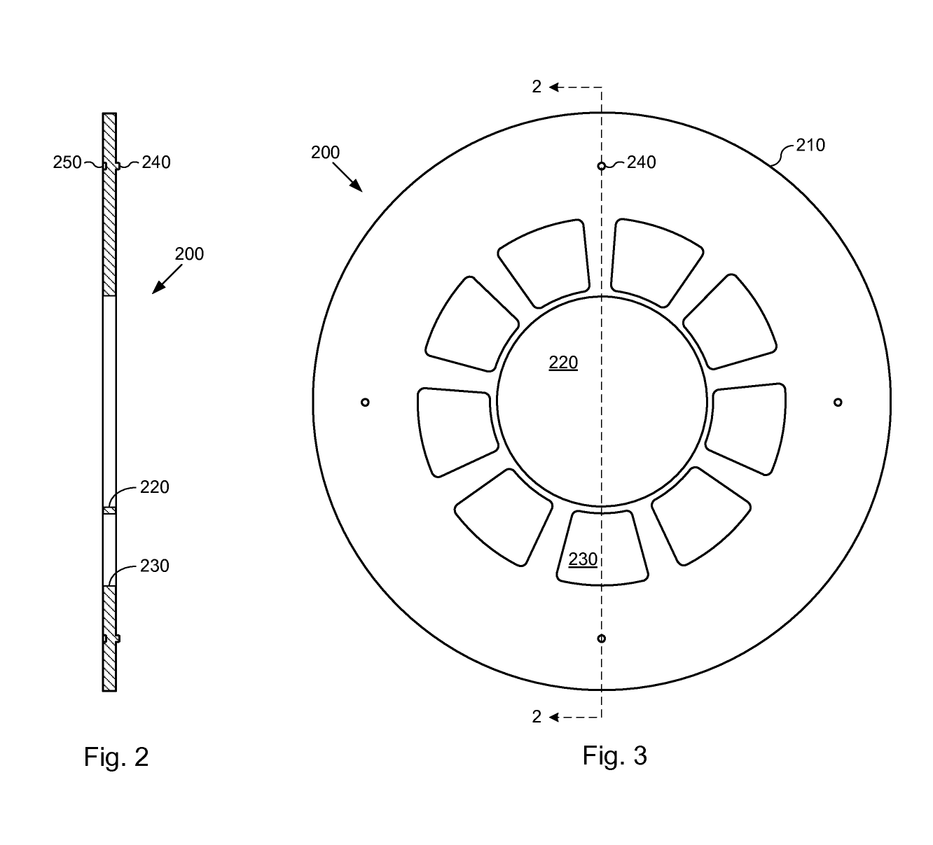

Referring to FIGS. 2 and 3, a lamination suitable for use in stator core 100 is shown. Each lamination is a thin disk of steel or other ferromagnetic material which has the shape of a cross-section of the stator core. The laminations normally have a thin layer of varnish or other non-conductive material which separates the laminations when they are stacked together.

Lamination 200 is generally annular, having a circular outer edge 210 and an inner aperture 220. When multiple laminations are stacked together, the outer edges of the laminations form a cylindrical outer surface of substantially the diameter as the inner surface 111 of stator housing 110. The inner apertures of the stacked laminations form the bore of the stator, within which the rotor of the motor will be positioned in the assembled motor.

Lamination 200 is configured to form a closed-slot stator core. This type of stator core has a set of passageways or “slots” which extend through the stator core. Magnet wire will later be threaded through these slots to form stator windings. Lamination 200 therefore includes a plurality of slot apertures (e.g., 230) that will form slots of the stator core.

Lamination 200 includes a set of “dimples”. Each dimple has a bump (e.g., 240) on one side of the lamination and a corresponding depression (e.g., 250) on the opposite side of the lamination. The pattern of the dimples on each lamination is the same, so that when the laminations are stacked together, the bumps of one lamination fit within the depressions of an adjacent lamination. In one embodiment, the dimples of the laminations are formed by partially punching these features in the laminations. When the laminations are stacked together, the dimples interlock to prevent each of the laminations from rotating with respect to the adjacent laminations. It should be noted that the dimples can be any suitable size and shape, and there may be any appropriate number of dimples on each lamination. Additionally, the dimples may be formed so that all of the bumps are on the same side of the lamination, or they may be on both sides of the lamination.

As noted above, a set of identical laminations are stacked and inserted into a stator housing to form the stator core. After the stacked laminations are inserted into the housing, snap rings are positioned in corresponding snap ring grooves on the inner surface of the housing to maintain the position of the lamination stack within the housing. In one embodiment, the lamination at each end of the stack is welded to the adjacent snap ring to prevent the lamination from rotating with respect to the snap ring, and the snap ring is welded to the housing. In an alternative embodiment, the end laminations may be welded to the housing itself. By welding the end laminations to the snap rings or housing, these laminations, and consequently the other, interlocked laminations, are prevented from rotating with respect to the housing.

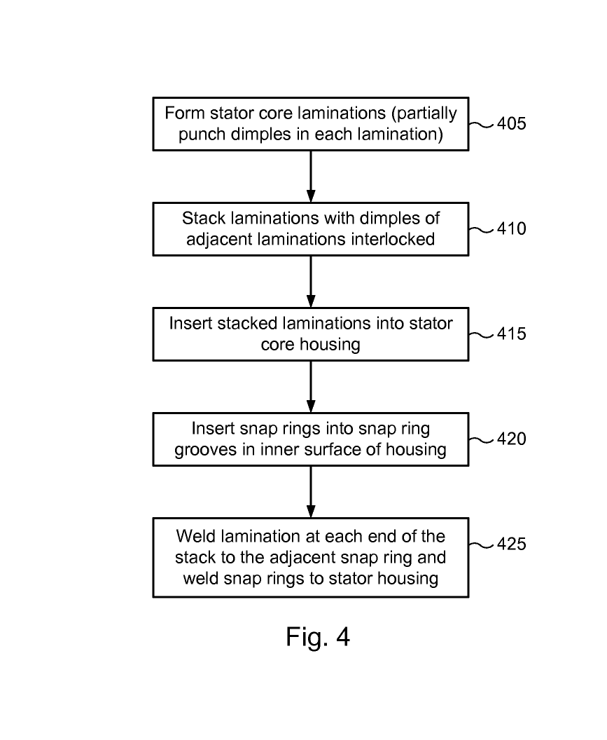

The stator core described above is one of many embodiments of the present invention. Another exemplary embodiment may comprise a method for compressionless, encapsulant-free manufacture of a stator. Referring to FIG. 4, a flow diagram illustrating this method is shown. At step 405, a set of stator core laminations are formed. Each of the laminations is identical, and each has a set of one or more dimples formed thereon. The laminations may, for instance, be punched from a sheet of metal or other conductive material, and the dimples may be partially punched in the laminations. The laminations are then stacked and aligned so that the dimples of adjacent laminations are interlocked (step 410). The stack of laminations is then inserted into a stator housing (step 415). The laminations are preferably sized to fit snugly within the housing, but this is not necessary to prevent rotation of the laminations within the housing. After the laminations are inserted into the stator housing, snap rings are inserted in the interior of the housing (step 420) to maintain the position of the stack of laminations within the housing. Finally, the lamination at each end of the stack is welded to the adjacent snap ring, and the snap ring is welded to the stator housing (step 425).

In one embodiment, the method may also include the step of removing the snap rings from the housing so that the stator core laminations can be removed from the housing. Because the interlocking dimples and recesses prevent the relative rotation of the laminations, no encapsulant was required, and the individual laminations can be easily separated from each other and reused.

These and other embodiments of the invention may provide a number of advantages over the prior art. For instance, as noted above, the laminations of a stator are conventionally compressed against each other so that friction between the laminations will prevent them from rotating with respect to each other. Because the dimples of the laminations in the present systems and methods are interlocked, the laminations are prevented from rotating with respect to each other without the need to compress the stack of laminations. By eliminating the compression, the resulting bending of the stator is eliminated, which in turn eliminates the need for costly and time consuming straightening operations.

Another advantage of the present systems and methods is the elimination of the need to use encapsulants in the stator. Conventionally, the slots of the stator are filled with an encapsulant such as epoxy or varnish to help prevent the laminations from rotating with respect to each other. The use of an encapsulant such as epoxy in a stator not only prevents adjacent laminations from rotating, but also prevents the impregnated laminations from being disassembled and repaired or reused. Because the interlocking dimples eliminate the need for an encapsulant to prevent relative rotation of the laminations, the laminations can be separated for repair, remanufacture or reuse in the event that the stator fails. This can save substantial time and money over simply discarding the stator in the event of a failure. Consequently, additional embodiments of the present invention may comprise methods for disassembly and/or remanufacture of stator cores of the type described herein.

While the present invention has been described with reference to particular embodiments, it should be understood that the embodiments are illustrative and that the scope of the invention is not limited to these embodiments. Many variations, modifications, additions and improvements to the embodiments described above are possible. For instance, In one embodiment, the stator core laminations may have simple dimples and recesses which interlock between the laminations, but alternative embodiments may have interlocking structures and recesses that have varying shapes, sizes and numbers. Each laminations may have all of the dimples (or all of the recesses) on the same side, they may be on both sides of each lamination.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A stator core comprising:
a stator housing; and
a plurality of stator core laminations that are stacked together and positioned within the stator housing;
wherein each of the plurality of stator core laminations is a disk having two opposing faces, wherein a first one of the faces has at least one protruding interlocking structure and a second one of the faces has at least one recess, wherein the interlocking structures and recesses of adjacent stator core laminations interlock and thereby prevent rotation each stator core lamination with respect to others of the plurality of stator core laminations.

2. The stator core of claim 1, wherein the at least one protruding interlocking structure comprises at least one dimple.

3. The stator core of claim 1, wherein the at least one recess in each stator core lamination is stamped, thereby forming the at least one protruding interlocking structure on the opposite side of the stator core lamination.

4. The stator core of claim 1, wherein each of the plurality of stator core laminations is identical.

5. The stator core of claim 1, further comprising a pair of snap rings, wherein the snap rings are positioned on opposite ends of the stack of the stator core laminations, wherein the snap rings are seated in corresponding grooves on an interior surface of the stator housing, and wherein the snap rings retain the stack of stator core laminations within the stator housing.

6. The stator core of claim 5, wherein each of the snap rings is welded to a corresponding end stator core lamination in the stack of stator core laminations, and wherein each of the snap rings is welded to the stator housing.

7. The stator core of claim 1, wherein the stator is encapsulant-free.

8. The stator core of claim 1, wherein the stack of stator core laminations is uncompressed.

9. The stator core of claim 1,
wherein the at least one protruding interlocking structure comprises at least one dimple, wherein the at least one recess in each stator core lamination is stamped, thereby forming the at least one dimple on the opposite side of the stator core lamination from the recess,
wherein the stack of stator core laminations is uncompressed,
the stator core further comprising a pair of snap rings, wherein the snap rings are positioned on opposite ends of the stack of the stator core laminations, wherein the snap rings are seated in corresponding grooves on an interior surface of the stator housing, wherein the snap rings retain the stack of stator core laminations within the stator housing, wherein each of the snap rings is welded to a corresponding end stator core lamination in the stack of stator core laminations, and wherein each of the snap rings is welded to the stator housing,
wherein the stator is encapsulant-free.

10. An electric submersible pump motor comprising:
a stator; and
a rotor rotatably positioned within the stator;
wherein the stator includes a stator housing and a plurality of stator core laminations that are stacked together and positioned within the stator housing;
wherein each of the plurality of stator core laminations is a disk having two opposing faces, wherein a first one of the faces has at least one protruding interlocking structure and a second one of the faces has at least one recess, wherein the interlocking structures and recesses of adjacent stator core laminations interlock and thereby prevent rotation of each stator core lamination with respect to others of the plurality of stator core laminations.

11. The electric submersible pump motor of claim 10, wherein the at least one protruding interlocking structure comprises at least one dimple.

12. The electric submersible pump motor of claim 10, wherein the at least one recess in each stator core lamination is stamped, thereby forming the at least one protruding interlocking structure on the opposite side of the stator core lamination.

13. The electric submersible pump motor of claim 10, wherein each of the plurality of stator core laminations is geometrically identical.

14. The electric submersible pump motor of claim 10, further comprising a pair of snap rings, wherein the snap rings are positioned on opposite ends of the stack of the stator core laminations, wherein the snap rings are seated in corresponding grooves on an interior surface of the stator housing, and wherein the snap rings retain the stack of stator core laminations within the stator housing.

15. The electric submersible pump motor of claim 14, wherein each of the snap rings is welded to a corresponding end stator core lamination in the stack of stator core laminations, and wherein each of the snap rings is welded to the stator housing.

16. The electric submersible pump motor of claim 10, wherein the stator is encapsulant-free.

17. The electric submersible pump motor of claim 10, wherein the stack of stator core laminations is uncompressed.

18. The electric submersible pump motor of claim 10,
wherein the at least one protruding interlocking structure comprises at least one dimple, wherein the at least one recess in each stator core lamination is stamped, thereby forming the at least one dimple on the opposite side of the stator core lamination from the recess,
wherein the stack of stator core laminations is uncompressed,
the stator core further comprising a pair of snap rings, wherein the snap rings are positioned on opposite ends of the stack of the stator core laminations, wherein the snap rings are seated in corresponding grooves on an interior surface of the stator housing, wherein the snap rings retain the stack of stator core laminations within the stator housing, wherein each of the snap rings is welded to a corresponding end stator core lamination in the stack of stator core laminations, and wherein each of the snap rings is welded to the stator housing,
wherein the stator is encapsulant-free.

19. A method for constructing a stator for an electric submersible pump motor, the method comprising:
providing a plurality of stator core laminations, wherein the stator core laminations have interlocking structures and recesses;
stacking the stator core laminations, wherein the interlocking structures and recesses of adjacent stator core laminations are interlocked;
inserting the stacked stator core laminations into a stator housing;
inserting snap rings in an interior of the stator housing and thereby retaining the stator core laminations in the stator housing;
welding a lamination at each end of the stack of stator core laminations to the adjacent snap ring, and welding the snap rings to the stator housing.

20. The method of claim 19, further comprising removing the snap rings from the housing and disassembling the stack of stator core laminations into individual stator core laminations.
